(19) United States
(12) Patent Application Publication
(10) Pub. No.: US 2025/0183726 A1
(43) Pub. Date: Jun. 5, 2025

(54) WIRELESS CHARGING DEVICE

(71) Applicant: Shenzhen Autral Technology Innovation Co., Ltd., Shenzhen (CN)

(72) Inventor: Jiawen Jiang, Shenzhen (CN)

(21) Appl. No.: 18/885,491

(22) Filed: Sep. 13, 2024

Related U.S. Application Data
(63) Continuation of application No. PCT/CN2023/135405, filed on Nov. 30, 2023.

(51) Int. Cl. H02J 50/40; H02J 50/10

(52) U.S. Cl. CPC H02J 50/40; H02J 50/10

(57) ABSTRACT

A wireless charging device includes: a base; a first support member connected to the base, the first support member having a first wireless charging module; a second support member connected to the base, the first support member having a first wireless charging module; and a connecting mechanism that is to connect the second support member to the first support member. The connecting mechanism is to allow the second support member to rotate relative to the first support member, and allow the second support member to move relative to the first support member along a direction perpendicular to the first support member, such that the second support member is movable toward and away from the first support member.

### CROSS REFERENCE TO RELATED APPLICATIONS

The present application is a continuation-application of International Application PCT/CN2023/135405, with an international filing date of Nov. 30, 2023, the contents of which are hereby incorporated by reference in its entirety.

### TECHNICAL FIELD

The present disclosure generally relates to wireless charging devices, and in particular relates to a wireless charging device capable of charging multiple portable electronic devices.

### BACKGROUND

Some conventional wireless charging devices can charge portable electronic devices such as mobile phones, headphones and watches. To avoid interference when charging multiple devices simultaneously, these charging devices need to reserve enough space for each device. Although such charging devices can meet basic needs, there is still room for improvement, especially in providing a more compact charging device.

### BRIEF DESCRIPTION OF DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric view of a wireless charging device according to one embodiment.

FIG. 2 is another isometric view of the wireless charging device view from a different perspective.

FIG. 3 is another isometric view of the wireless charging device with a second support member being rotated to a first extended position.

FIG. 4 is another isometric view of the wireless charging device with the second support member being rotated to the initial position.

FIG. 5 is a top view of the wireless charging device with the second support member being rotated to the initial position.

FIG. 6 is a schematic block diagram showing the connection between a power interface and multiple charging modules of the wireless charging device according to one embodiment.

FIG. 7 is an isometric view of the wireless charging device when charging a first portable electronic device, a second portable electronic device, and a third portable electronic device simultaneously with the second support member being rotated to the first extended position.

FIG. 8 is a side view of the wireless charging device when charging the first portable electronic device, the second portable electronic device, and the third portable electronic device simultaneously with the second support member being rotated to the first extended position.

FIG. 9 is an isometric view of the wireless charging device when charging the first portable electronic device, the second portable electronic device, and the third portable electronic device simultaneously with the second support member being rotated to a second extended position.

FIG. 10 is another isometric view of the wireless charging device when charging the first portable electronic device, the second portable electronic device, and the third portable electronic device simultaneously with the second support member being rotated to the second extended position.

FIG. 11 is another isometric view of the wireless charging device when charging the first portable electronic device, the second portable electronic device, and the third portable electronic device simultaneously with the second support member being rotated to the second extended position.

FIG. 12 is a top view of the wireless charging device when charging the first portable electronic device, the second portable electronic device, and the third portable electronic device simultaneously with the second support member being rotated to the second extended position.

FIG. 13 is a cross-sectional view of a connecting mechanism of the wireless charging device according to one embodiment.

FIG. 14 is an exploded view of the wireless charging device.

FIG. 15 is another exploded view of the wireless charging device.

FIG. 16 is another exploded view of the wireless charging device.

FIG. 17 is a front view of a shaft of the wireless charging device according to one embodiment.

FIG. 18 is a right-side view of the shaft of the wireless charging device according to one embodiment.

FIG. 19 is a rear view of the shaft of the wireless charging device according to one embodiment.

FIG. 20 is a left-side view of the shaft of the wireless charging device according to one embodiment.

FIG. 21 is a cross-sectional view of the wireless charging device with the second support member being located at the initial position.

FIG. 22 is another cross-sectional view of the wireless charging device with the second support member being located at the second extended position.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

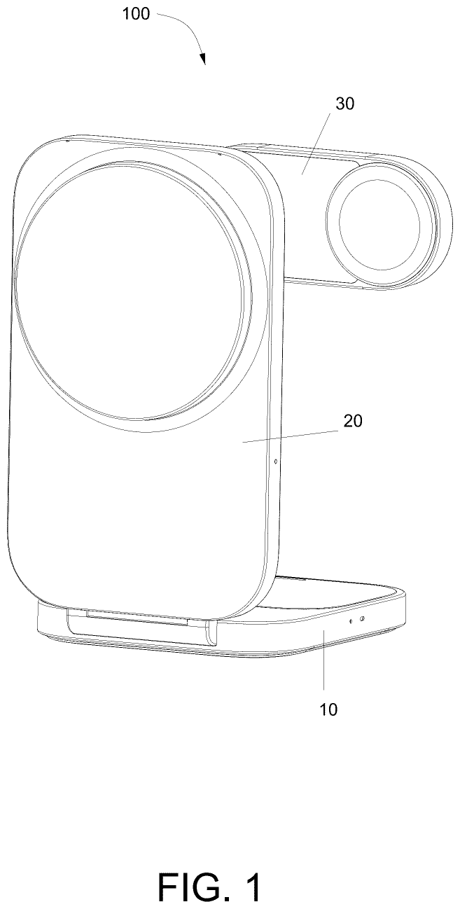

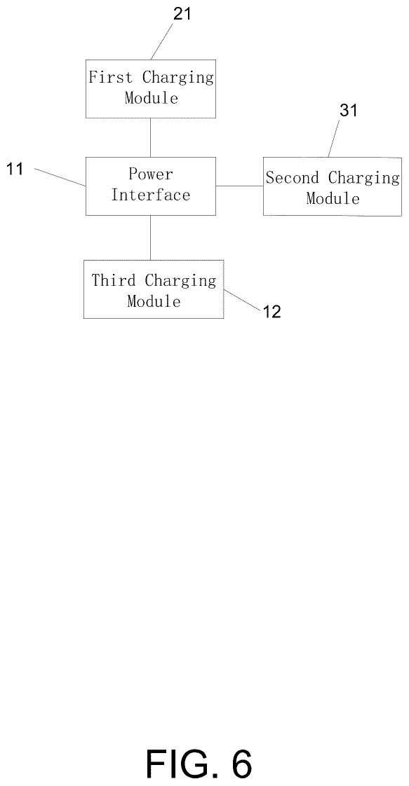

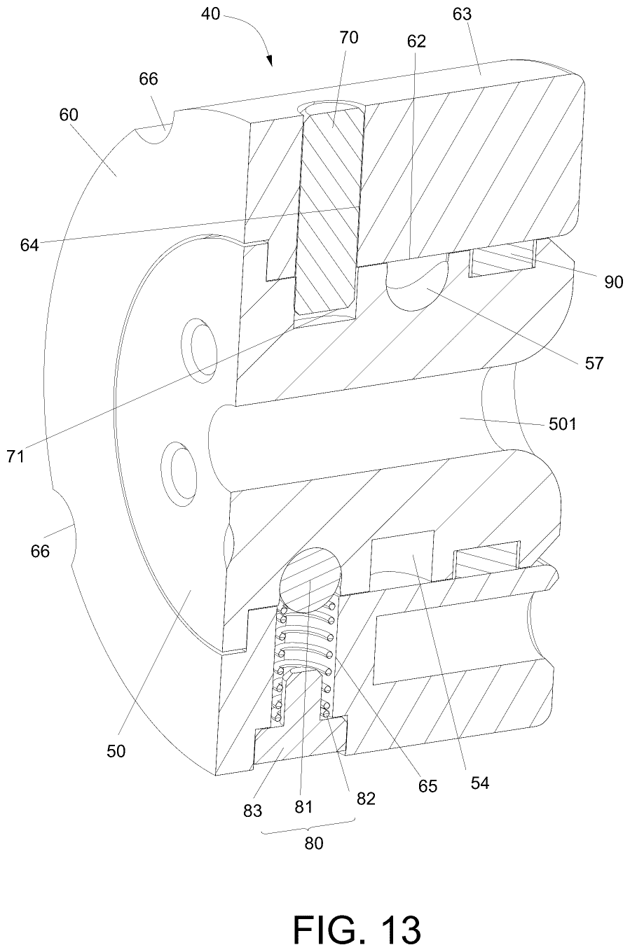

Referring to FIGS. 1 to 4, in one embodiment, a wireless charging device 100 may include a base 10, a first support member 20, a second support member 30, and a connecting mechanism 40 (see FIG. 13). The first support member 20 is connected to the base 10, and the first support member 20 may include a first wireless charging module 21 (see FIG. 6). The second support member 30 is connected to the first support member 20, and the second support member 30 may include a second wireless charging module 31 (see FIG. 6). The connecting mechanism 40 connects the second support member 30 to the first support member 10, and the connecting mechanism 40 is to allow the second support member 30 to rotate relative to the first support member 20, and allow the second support member 30 to move relative to the first support member 20 along a direction perpendicular to the first support member 20, so that the second support member 30 can move toward and away from the first support member 20.

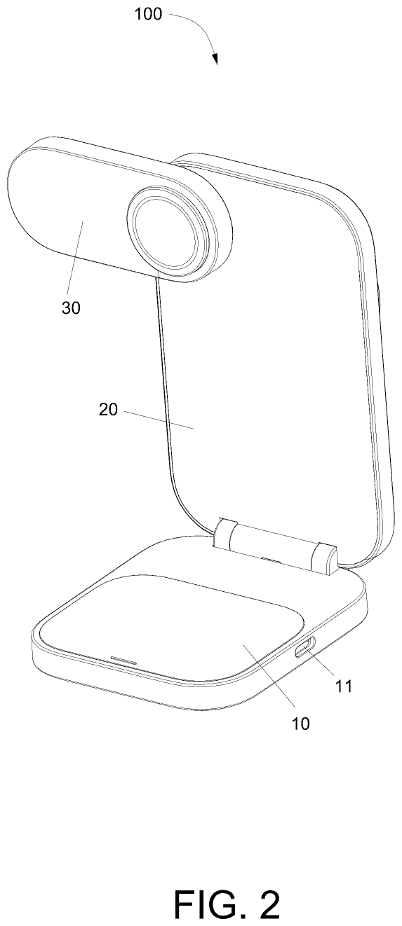

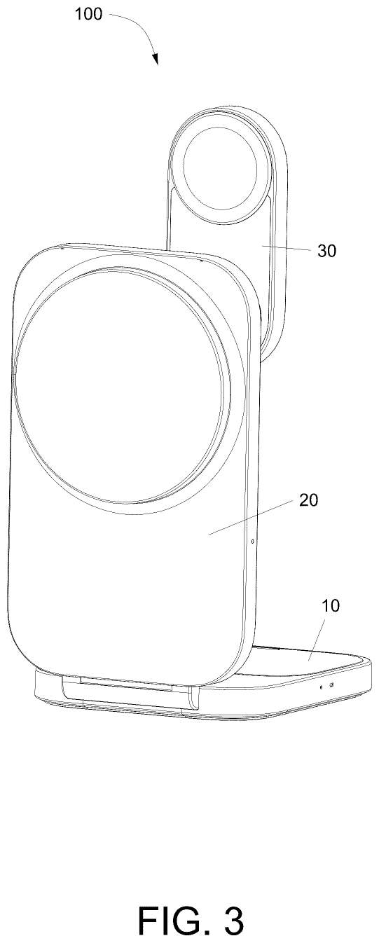

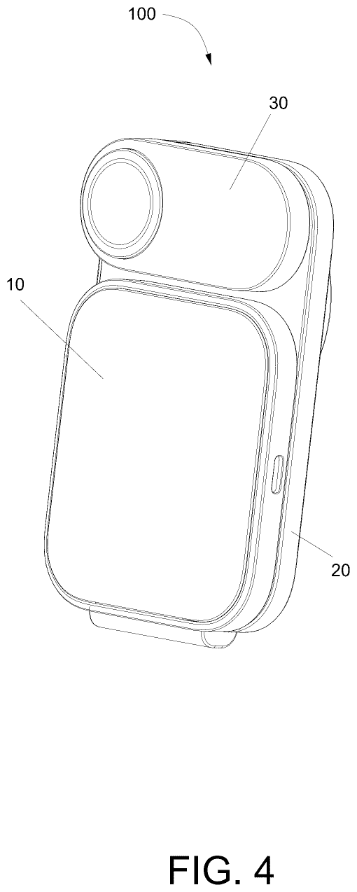

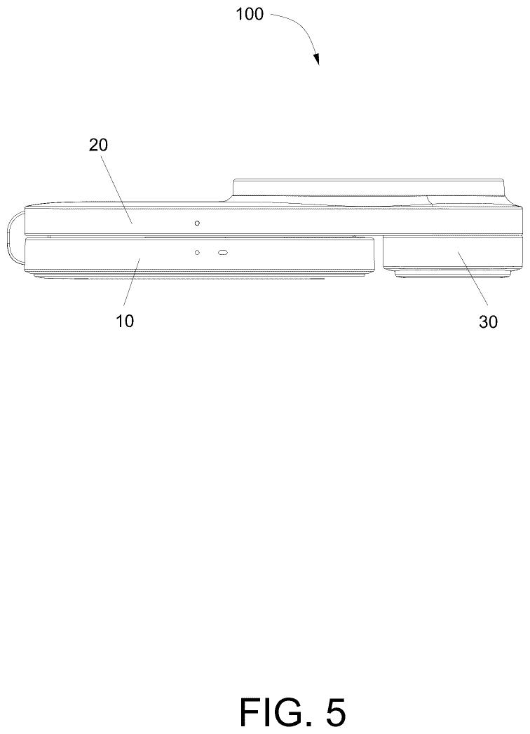

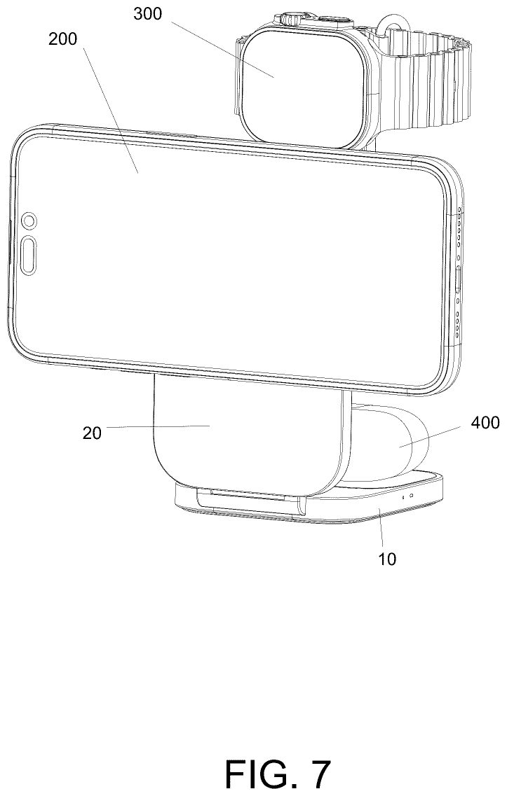

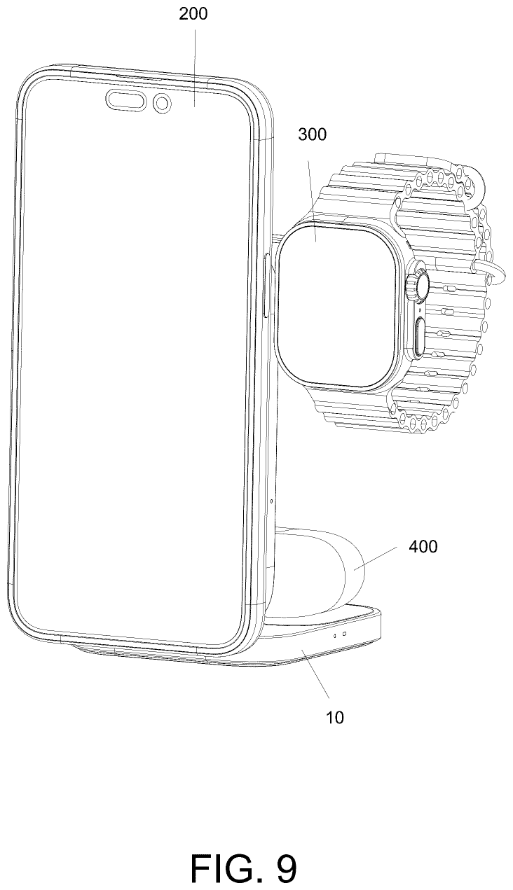

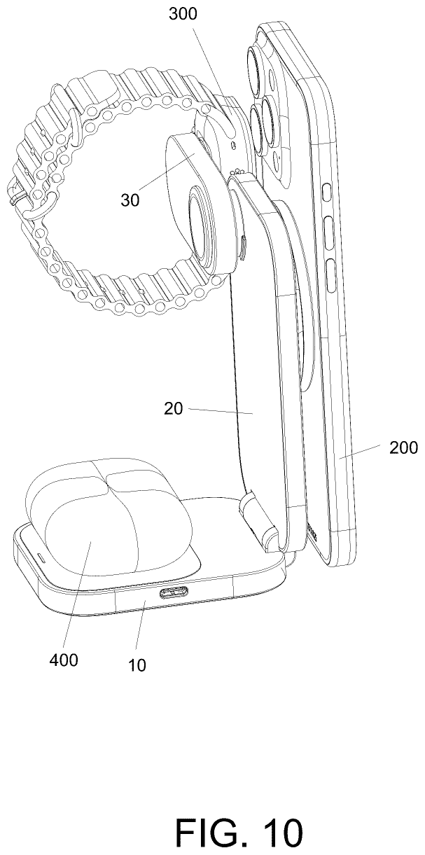

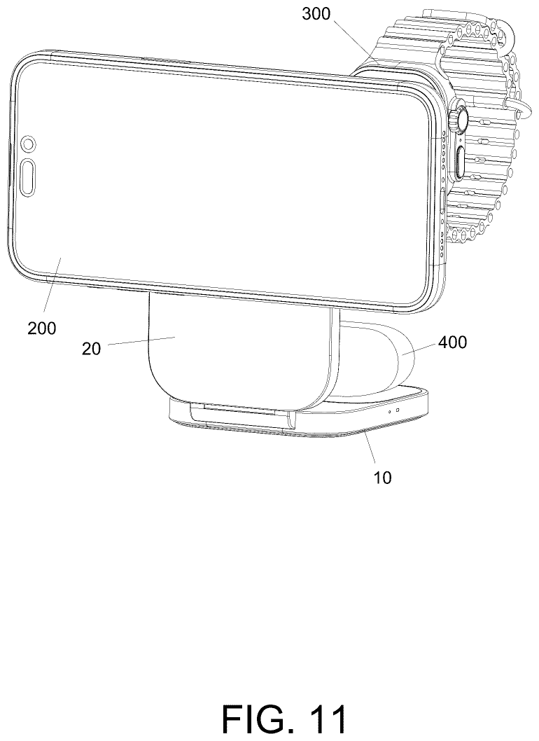

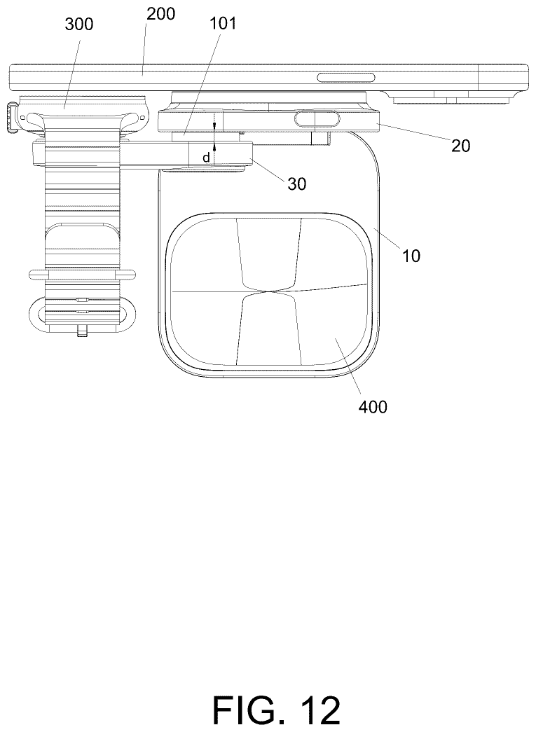

Referring to FIGS. 7-12, with the above-mentioned configuration, the first support member 20 can wirelessly charge a first portable electronic device 200 (e.g., a mobile phone), the second support member 30 can wirelessly charge the second portable electronic device 300 (e.g., a smart watch), and the wireless charging device 100 can simultaneously charge the first portable electronic device 200 and the second portable electronic device 300. The second support member 30 can be rotated to different positions relative to the first support member 20. For example, when the wireless charging device 100 needs to be stored, the second support member 30 can be rotated to the initial position shown in FIG. 4, at which time, the second support member 30 is in contact with or close to the first support member 20, as shown in FIG. 5. The second support member 30 can be rotated to a first extended position shown in FIG. 3. At this time, the second support member 30 can charge the second portable electronic device 300. The second support member 30 can be rotated to a second extended position shown in FIGS. 1 and 2, at which time, the second support member 30 can charge the second portable electronic device 300, as shown in FIGS. 9 through 12.

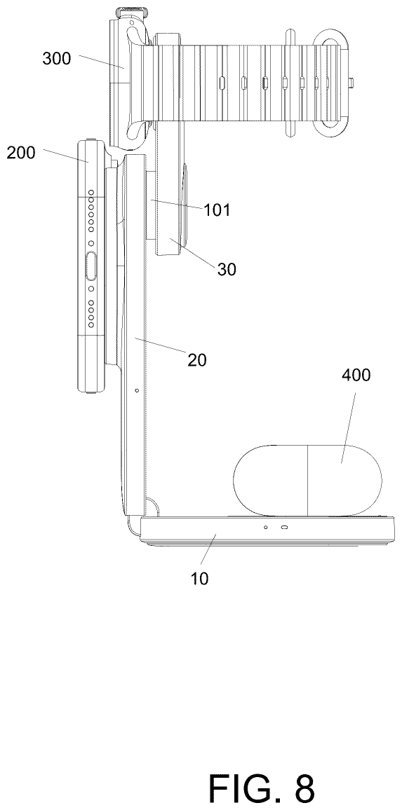

Comparing the initial position shown in FIG. 5 with the first extended position and the second extended position shown in FIGS. 8, 10 and 12, it can be seen that the second support member 30 not only has rotated relative to the first support member 20, but also translated relative to the first support member 20. Specifically, in the initial position, the second support member 30 is in contact with or nearly in contact with the first support member 20. While in the first extended position and the second extended position, a gap 101 with a width of d is formed between the second support member 30 and the first support member 20, indicating that the second support member 30 has translated in a direction away from the first support member 20, and the translation distance is d. This allows the wireless charging device 100 to charge the first portable electronic device 200 and the second portable electronic device 300 simultaneously without interference between the first portable electronic device 200 and the second portable electronic device 300. When charging is completed, the second support member 30 can be rotated to the initial position. At this time, the second support member 30 is in contact with or nearly in contact with the first support portion 20, so that the wireless charging device 100 has a smaller thickness, thereby being more convenient to carry and store.

In one embodiment, the base 10 is a substantially flat rectangular parallelepiped, which can be rotatably connected to the lower end of the first support member 20 and faces the back of the first support member 20. When the wireless charging device 100 is not in use, the base 10 can be rotated to the folded position shown in FIGS. 4 and 5, at which time, the base 10 is attached to or nearly attached to the first support member 20, and the wireless charging device 100 as a whole is substantially a flat rectangular parallelepiped. When the wireless charging device 100 is in use, the base 10 can be rotated from the folded position to the unfolded position shown in FIGS. 1 and 2, at which time, the angle between the base 10 and the first support member 20 is less than 90 degrees, so that the first support member 20 is inclined relative to the substantially horizontal base 10.

A power interface 11 is provided on a side of the base 10 (see FIGS. 2 and 6), and the power interface 11 can be connected to a power outlet through a power cable. Referring to FIG. 6, in one embodiment, a third wireless charging module 12 is provided in the base 10, and the first wireless charging module 21, the second wireless charging module 31 and the third wireless charging module 12 are all electrically connected to the power interface 11. The first wireless charging module 21, the second wireless charging module 31 and the third wireless charging module 12 can be based on the inductive energy transmission technology according to the Qi standard, or can be based on the magnetic coupling wireless energy transmission technology based on the resonance of the Rezence standard. The above wireless charging standards or other publicly disclosed wireless charging standards are all known and will not be repeated here. One or more magnets are arranged near the first wireless charging module 21, the second wireless charging module 31 and the third wireless charging module 12, which allows the first portable electronic device 200, the second portable electronic device 300 and the third portable electronic device 400 (such as the earphone charging case) containing magnets to be attached to the first support member 20, the second support member 30 and the base 10 respectively. The first portable electronic device 200, the second portable electronic device 300 and the third portable electronic device 400 respectively include wireless charging modules, which are based on the same wireless charging standard as the first wireless charging module 21, the second wireless charging module 31 and the third wireless charging module 12. In this way, when the first portable electronic device 200, the second portable electronic device 300 and the third portable electronic device 400 are attracted to the first support member 20, the second support member 30 and the base 10, the electric energy can be transmitted to the first portable electronic device 200, the second portable electronic device 300 and the third portable electronic device 400 in a wireless manner.

In one embodiment, the first support member 20 is substantially a flat cuboid, and the second support portion 30 is connected to the back of the first support member 20 and close to the top end of the second support member 30. The length of the second support member 30 is substantially equal to the width of the first support member 20.

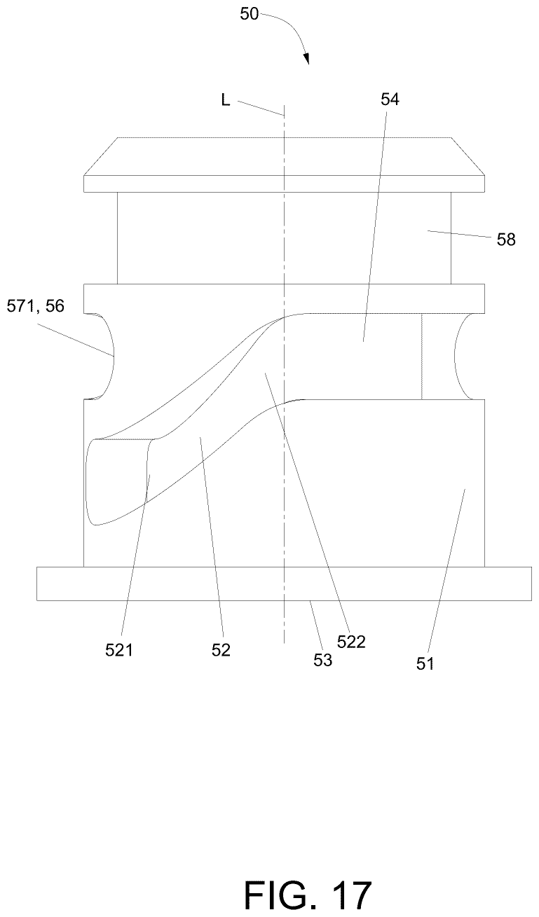

Referring to FIGS. 13 to 16, the connecting mechanism 40 includes a shaft 50, a barrel 60 and a pin 70. The shaft 50 is fixed to the first support member 20. The barrel 60 is fixed to the second support member 30 and defines a receiving chamber 61. The shaft 50 is received in the receiving chamber 61. The barrel 60 can rotate relative to the shaft 50. The pin 70 is fixed to the barrel 60, and one end 71 of the pin 70 protrudes from the inner lateral surface 62 of the receiving chamber 61. The outer lateral surface 51 (see FIG. 17) of the shaft 50 defines a first guide groove 52 (see FIG. 17). The first guide groove 52 is inclined relative to the axis L of the shaft 50. The end 71 of the pin 70 is received in the first guide groove 52 and can move along the first guide groove 52.

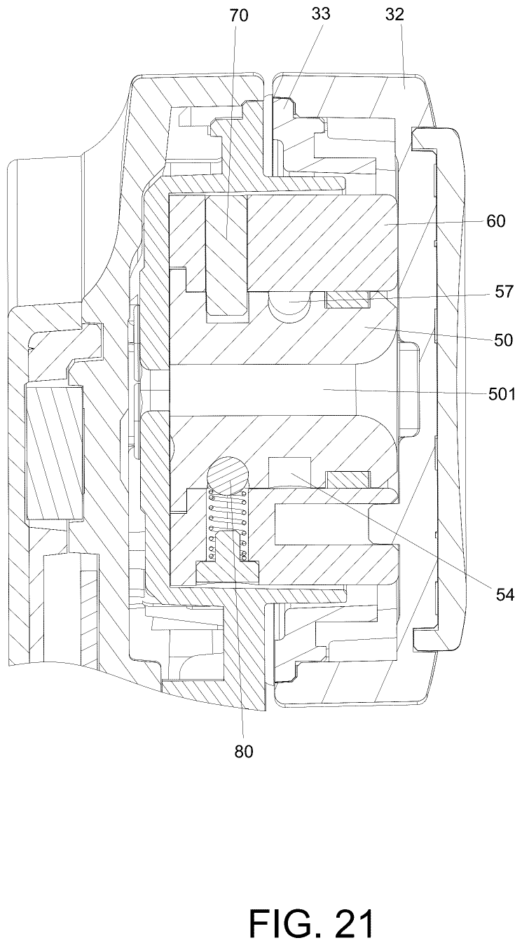

Referring to FIG. 17, the shaft 50 is a solid of revolution. One end face 53 of the shaft 50 is fixed to the back of the first support member 20. The starting point 521 of the first guide groove 52 is close to the end face 53, and the first guide groove 52 extends from the starting point 521 along the lateral face 51 of the shaft 50 in a direction away from the end face 53 to the end point 522. When the second support member 30 is located at the initial position shown in FIG. 4, the end 71 of the pin 70 is located at the starting point 521 of the first guide groove 52 (see FIGS. 13 and 21). When the second support member 30 is rotated by the user, the end 71 of the movable pin 70 moves along the first guide groove 52. Since the first guide groove 52 is inclined relative to the axis L of the shaft 50, and the axis L of the shaft 50 is the axis of rotation of the barrel 60, the end 71 of the pin 70 moving along the first guide groove 52 will cause the barrel 60 to gradually move away from the first support member 20 along the axis L, thereby driving the second support member 30 to translate and move away from the first support member 20 along the axis L that is perpendicular to the first support member 20. From the above-mentioned description and FIGS. 7-12, it is apparent that a reverse rotation of the support member 30 toward its initial position (see FIG. 4) will cause the barrel 60 to gradually move toward the first support member 20 along the axis L, thereby driving the second support member 30 to translate and move toward the first support member 20 along the axis L that is perpendicular to the first support member 20.

In one embodiment, the starting point 521 and the end point 522 of the first guide groove 52 are 90 degrees apart in the circumferential direction. That is, when the end 71 of the pin 70 moves from the starting point 521 to the end point 522 along the first guide groove 52, the barrel 60 rotates 90 degrees relative to the shaft 50. In other words, when the end 71 of the pin 70 moves from the starting point 521 to the end point 522 along the first guide groove 52, the second support member 30 rotates 90 degrees relative to the first support member 20, from the initial position shown in FIG. 4 to the first extended position shown in FIGS. 3 and 7. At this time, the second support member 30 is substantially in a vertical state and extends upward from the top end of the first support member 20. In this case, the second portable electronic device 300 can be attracted to the second support member 30 (see FIGS. 7 and 8). Since the second support member 30 is translated a distance away from the first support member 20, there is sufficient space between the surface of the second support member 30 in contact with the second portable electronic device 300 and the surface of the first support member 20 in contact with the first portable electronic device 200, so that the second portable electronic device 300 will not interfere with the first portable electronic device 200, regardless of whether the first portable electronic device 200 is placed vertically or horizontally.

From the above description, it is understood that through the connecting mechanism 40, the second support member 30 gradually moves away from the first support member 20 as it rotates from the initial position to the first extended position.

Referring to FIG. 13, the barrel 60 is cylindrical, and the receiving chamber 61 passes through opposite ends of the barrel 60. The diameter of the receiving chamber 61 is equal to or slightly larger than the diameter of the shaft 50. In one embodiment, the barrel 60 further defines a through hole 64 extending from its outer lateral surface 63 to the lateral side surface 62 of the receiving chamber 61, and the pin 70 is received in the through hole 64, and the end 71 of the pin 70 protrudes from the inner lateral surface 62 of the receiving chamber 61.

The pin 70 is cylindrical, and its diameter is equal to or slightly less than the width of the first guide groove 52, so that the barrel 60 will not move along the axis L of the shaft 50 relative to the shaft 50 when not rotating.

Referring to FIG. 17, in one embodiment, the lateral surface 51 of the shaft 50 is further provided with a second guide groove 54 in communication with the first guide groove 52, and the second guide groove 54 is parallel to the end surface 53 of the shaft 50 connected to the first support member 20. Since the end surface 53 is parallel to the back of the first support member 20, the second guide groove 54 is parallel to the back of the first support member 20. Therefore, when the end 71 of the pin 70 moves from the first guide groove 52 to the second guide groove 54, the movement of the end 71 of the pin 70 in the second guide groove 54 will not cause the barrel 60 to move along the axis L of the fixed column 50, that is, the distance between the second support member 30 and the first support member 20 remains unchanged.

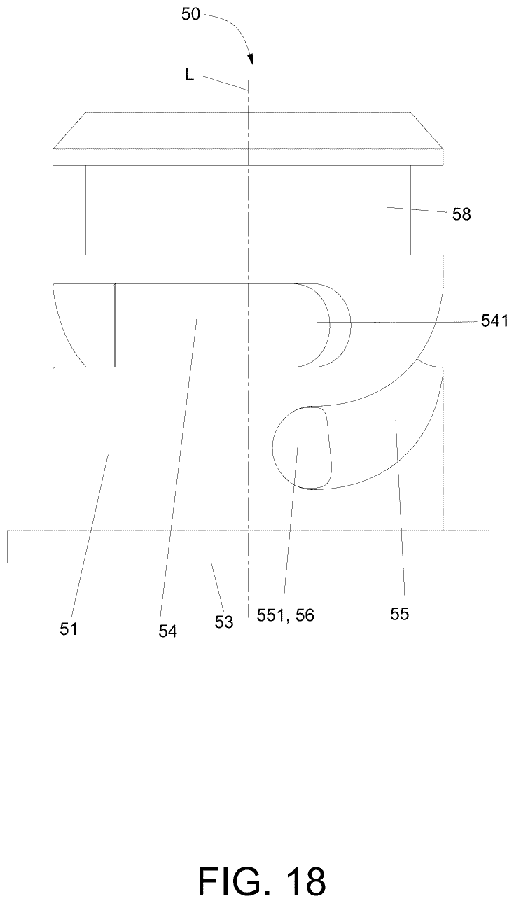

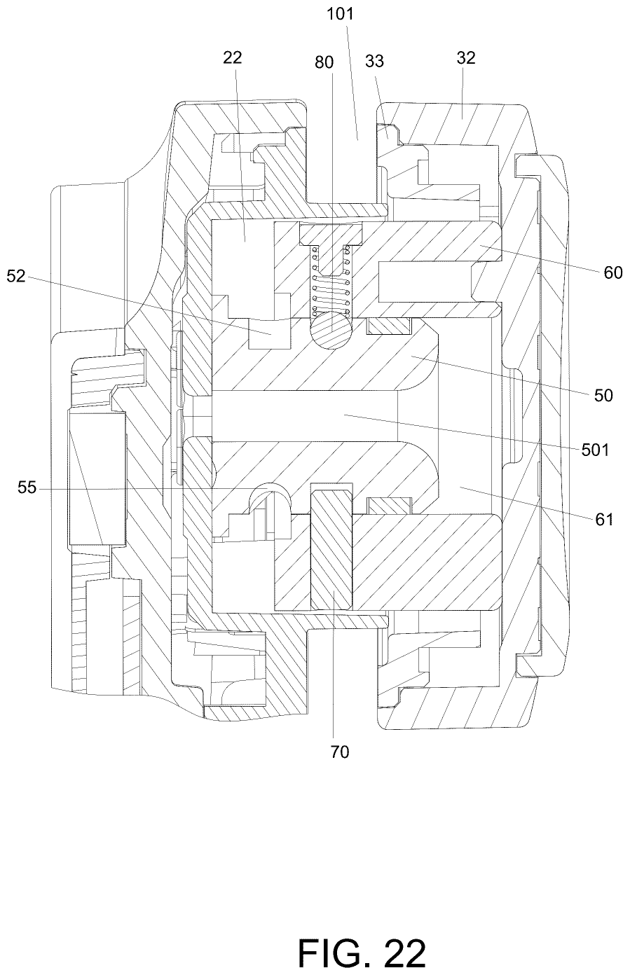

Referring to FIGS. 17 and 18, the second guide groove 54 intersects with the first guide groove 52 at the end point 522, and the second guide groove 54 extends from the end point 522 to the end point 541. In one embodiment, the end point 522 and the end point 541 are 90 degrees apart in the circumferential direction. That is, when the end 71 of the movable pin 70 moves from the end point 522 to the end point 541 along the second guide groove 54 (see FIG. 22), the barrel 60 rotates 90 degrees relative to the shaft 50. In other words, when the end 71 of the pin 70 moves from the end point 522 to the end point 541 along the second guide groove 54, the second support member 30 rotates 90 degrees relative to the first support member 20, from the first extended position shown in FIGS. 3 and 7 to the second extended position shown in FIGS. 1, 9 and 11. At this time, the second support member 30 is approximately in a horizontal state and extends from one side of the first support member 20. In this case, the second portable electronic device 300 can be attracted to the second support member 30. Since the second support member 30 and the first support member 20 are spaced a distance apart from each other, there is sufficient space between the surface where the second support member 30 contacts the second portable electronic device 300 and the surface where the first support member 20 contacts the first portable electronic device 200, so that the second portable electronic device 300 will not interfere with the first portable electronic device 200, regardless of whether the first portable electronic device 200 is placed vertically or horizontally.

From the above description, through the connecting mechanism 40, the distance between the second support member 30 and the first support member 20 remains unchanged as it rotates from the first extended position to the second extended position.

In another embodiment, the first guide groove 52 extends in a direction parallel to the axis L of the fixing column 50 and is perpendicular to the second guide groove 54. In this case, when the second support member 30 is needed to charge the second portable electronic device 300, the user can pull the second support member 30 to move the end 71 of the pin 70 along the first guide groove 52 to the end point 522. In this case, the second support member 30 is translated relative to the first support member 20 for a distance and away from the first support member 20. Then, the user can rotate the second support member 30 to a desired position as needed to allow the second support member 30 to charge the second portable electronic device 300. In the previous embodiment, the rotation of the second support member 30 relative to the first support member 20 and the translation of the second support member 30 relative to the first support member 20 occur simultaneously. In this embodiment, the second support member 30 is first translated relative to the first support member 20 for a distance and then rotated to the desired position.

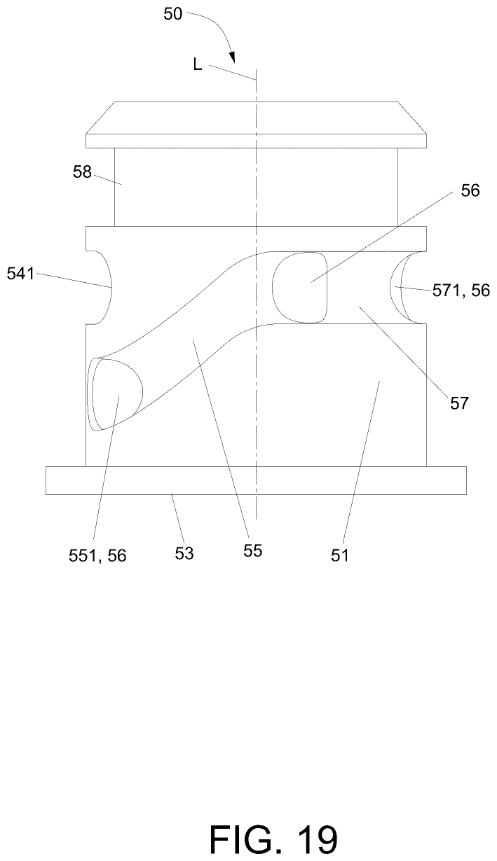

Referring to FIGS. 13, 19 and 20, in one embodiment, the lateral surface 51 of the shaft 50 is further provided with a third guide groove 55, and the connecting mechanism 40 further includes a spring-loaded ball 80. The third guide groove 55 has the same shape as the first guide groove 52. The spring-loaded ball 80 protrudes from the inner lateral surface 62 of the receiving chamber 61 of the barrel 60 and is received in the third guide groove 55. A number of dents 56 are provided in the third guide groove 55. The spring-loaded ball 80 can move along the third guide groove 55 and can be positioned in any of the dents 56.

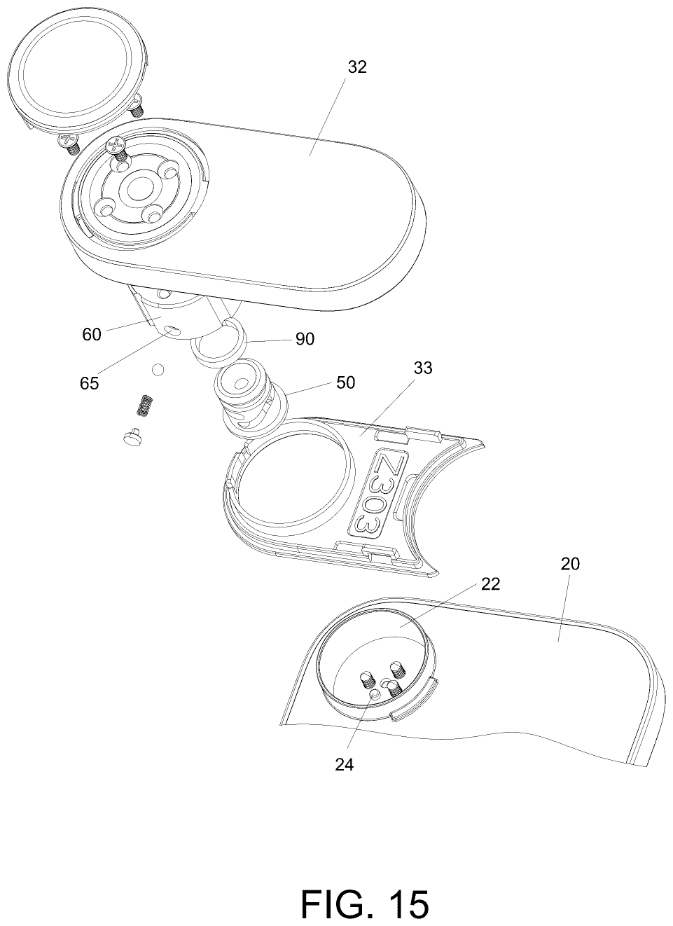

In one embodiment, the barrel 60 further defines a through hole 65 (see FIG. 15) extending from its outer side surface 63 to the inner side surface 62 of the receiving chamber 61, and the spring-loaded ball 80 passes through the through hole 65 and protrudes from the inner lateral surface 62 of the receiving chamber 61. Referring to FIG. 13, the spring-loaded ball 80 includes a sphere 81, a spring 82 and a connecting member 83. The opposite ends of the spring 82 are respectively connected to the sphere 81 and the connecting member 83. The spring 82 and the connecting member 83 are received in the through hole 65, and the spring 82 is in a compressed state.

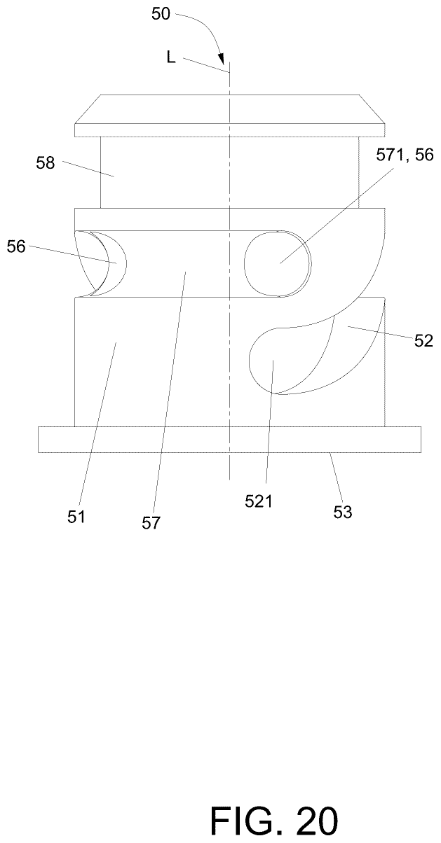

In one embodiment, the lateral surface 51 of the shaft 50 is further provided with a fourth guide groove 57 in communication the third guide groove 55, and the fourth guide groove 57 is parallel to the end surface 53 of the shaft 50 connected to the first support member 20. In the state shown in FIG. 18, the starting point 551 of the third guide groove 55 is located directly below the end point 541 of the second guide groove 54. In the state shown in FIG. 20, the end point 571 of the fourth guide groove 57 is located directly above the starting point 521 of the first guide groove 52. The starting point 521 of the first guide groove 52 and the starting point 551 of the third guide groove 55 are spaced 180 degrees in the circumferential direction, which can be seen from FIG. 21. That is, when the end 71 of the pin 70 is located at the starting point 521 of the first guide groove 52, the ball 81 of the spring-loaded ball 80 is located at the starting point 551 of the third guide groove 55. As can be seen from FIG. 22, when the end 71 of the pin 70 is located at the end point 541 of the second guide groove 54, the ball 81 of the spring-loaded ball 80 is located at the end point 571 of the fourth guide groove 57. The end 71 of the pin 70 and the ball 81 of the spring-loaded ball 80 move simultaneously. That is, when the end 71 of the pin 70 moves from the starting point 521 along the first guide groove 52, the ball 81 of the spring-loaded ball 80 moves from the starting point 551 along the third guide groove 55. When the end 71 of the moving pin 70 moves to the end point 541 of the second guide groove 54, the ball 81 of the spring-loaded ball 80 moves to the end point 571 of the fourth guide groove 57.

In one embodiment, the number of the dents 56 is 3, and the first dent 56 is located at the starting point 551 of the third guide groove 55. The second dent 56 is located at the intersection of the third guide groove 55 and the fourth guide groove 57. When the ball 81 of the spring-loaded ball 80 is located in the second dent 56, the end 71 of the pin 70 is located at the end point 522 of the first guide groove 52. The third dent 56 is located at the end point 571 of the fourth guide groove 57. The disengagement of the ball 81 of the spring-loaded ball 80 with the dent 56 can lock the barrel 60 to the shaft 50, so that the barrel 60 will not easily move without external force from the user. By forming the dents 56 in the above three positions, when the second support member 30 rotates to the initial position shown in FIG. 4, the first extended position shown in FIG. 3, and the second extended position shown in FIG. 1, the ball 81 of the spring-loaded ball 80 is exactly accommodated in the above three dents 56, which is conducive to the second support member 30 being kept in the above initial position, the first extended position, and the second extended position. In addition, when the ball 81 of the spring-loaded ball 80 is pushed into one dent 56 by the spring 82, a collision sound is generated, and this feedback can remind the user that the second support member 30 has been rotated to the initial position, the first extended position, or the second extended position.

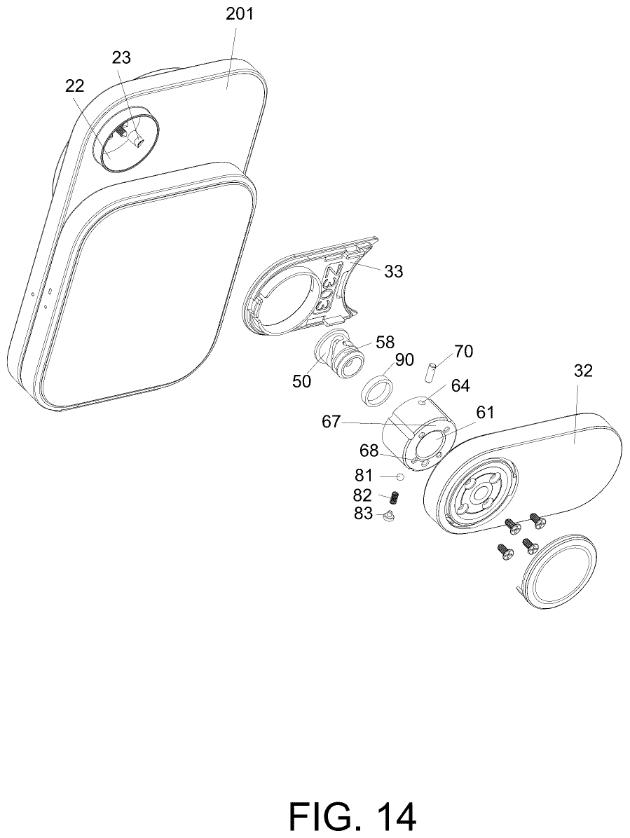

Referring to FIG. 14, in one embodiment, the wireless charging device 100 further includes a rubber ring 90, and the lateral surface 51 of the shaft 50 is further provided with an annular groove 58. The rubber ring 90 is arranged around the shaft 50 and received in the annular groove 58. The rubber ring 58 contacts the inner lateral surface 62 of the receiving chamber 61 of the barrel 60 to provide damping when the barrel 60 rotates relative to the shaft 50. In the above-mentioned initial position, the first extended position and the second extended position, the damping combined with the engagement of the ball 81 of the spring-loaded ball 80 with one dent 56 can stably maintain the second support member 30 in the above-mentioned three positions. When the second support member 30 is rotated to a position other than the above-mentioned three positions, the above-mentioned damping can maintain the second support member 30 in the position, so that the second support member 30 can charge the second portable electronic device in the position.

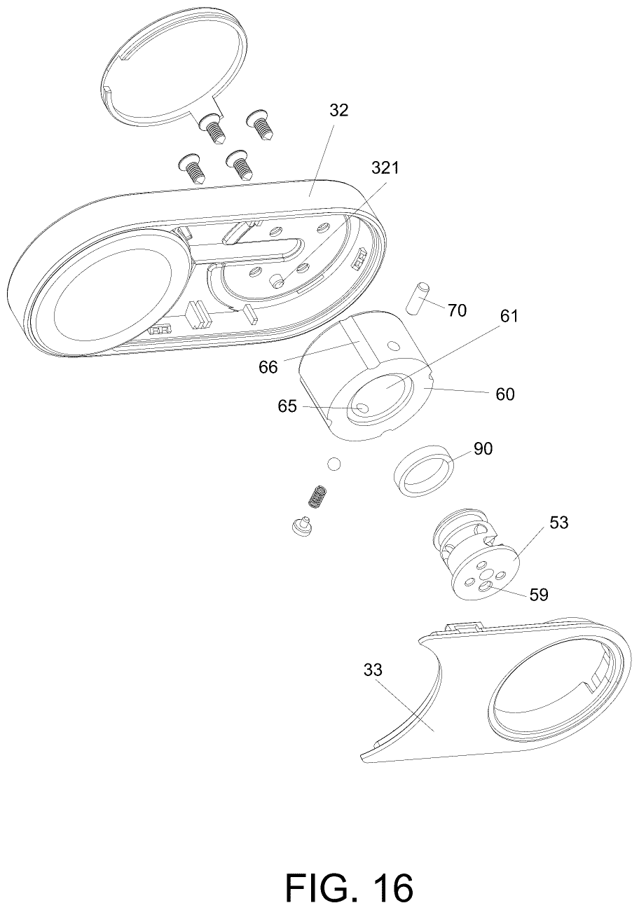

In one embodiment, the first support member 20 may define an accommodation chamber 22 located on the back 201 (see FIG. 14) thereof. The barrel 60 is partially received in the accommodation chamber 22. The first support member 20 further include an elastic member 23 protruding from the inner lateral surface of the accommodation chamber 22, and the outer lateral surface of the barrel 60 is provided with a number of grooves 66 extending along its length direction (see FIGS. 13 and 16). When the outer lateral surface of the barrel 60 contacts the elastic member 23, the elastic member 23 is elastically deformed by pressure. When the elastic member 23 is fit in one of the grooves 66, the elastic member 23 rebounds, so that the barrel 60 can be locked to the first support member 20. Through the engagement of the grooves 66 with the elastic member 23, combined with the damping provided by the rubber ring 58 and the engagement of the ball 81 of the spring-loaded ball 80 with the dents 56, the second support member 30 can be kept in the desired position when the second portable electronic device 300 is attracted to the second support member 30.

Referring to FIGS. 14 to 16, the shaft 50 can be fixed to the accommodation chamber 22 of the first support member 20 by screws. The accommodation chamber 22 is provided with a mistake-proofing post 24, which is received in a receiving hole 59 in the end face 53 of the shaft 50, ensuring that the shaft 50 is fixed to the first support member 20 in the correct orientation. The second support member 30 includes a first shell 32 and a second shell 33 connected to each other, and the barrel 60 is partially received in the space defined by the first shell 32 and the second shell 33. The end face 67 of the barrel 60 away from the first support member 20 is fixed to the first shell 32 by screws. The first shell 32 is provided with a mistake-proofing post 321, which is received in a receiving hole 68 on the end face 67 of the barrel 60, ensuring that the barrel 60 is fixed to the first shell 32 in the correct orientation.

Referring to FIG. 21, in one embodiment, the shaft 50 further defines a through hole 501 extending through opposite ends thereof, and the through hole 501 allows a power line/signal line to pass through to electrically connect the electronic components in the second support member 30 with the electronic components in the first support member 20 and/or the base 10.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A wireless charging device comprising:
a base;
a first support member connected to the base, the first support member comprising a first wireless charging module;
a second support member connected to the base, the first support member comprising a first wireless charging module; and
a connecting mechanism configured to connect the second support member to the first support member, wherein the connecting mechanism is configured to allow the second support member to rotate relative to the first support member, and allow the second support member to move relative to the first support member along a direction perpendicular to the first support member, such that the second support member is movable toward and away from the first support member.

2. The wireless charging device of claim 1, wherein the connecting mechanism is configured to allow the second support member to gradually move away from the first support member during rotation from an initial position to a first extended position.

3. The wireless charging device of claim 2, wherein the connecting mechanism is configured to allow the second support member to maintain a constant distance from the first support member during rotation from the first extended position to a second extended position.

4. The wireless charging device of claim 2, wherein the connecting mechanism comprises a shaft, a barrel and a pin, the shaft is fixed to the first support member, the barrel is fixed to the second support member and defines a receiving chamber to receive the shaft, the barrel is rotatable relative to the shaft, the pin is fixed to the barrel and protrudes from an inner lateral surface of the receiving chamber, the shaft comprises an outer lateral surface and defines a first guide groove in the outer lateral surface, the first guide groove is inclined relative to an axis of the shaft, the pin is partly received in the first guide groove, and is movable along the first guide groove.

5. The wireless charging device of claim 4, wherein the shaft further defines a second guide groove in the outer lateral surface in communication with the first guide groove, and the second guide groove is parallel to an end surface of the shaft connected to the first support member.

6. The wireless charging device of claim 4, wherein the shaft further defines a third guide groove in the outer lateral surface, the connecting mechanism further comprises a spring-loaded ball, the third guide groove has the same shape as the first guide groove, the spring-loaded ball protrudes from the inner lateral surface of the receiving chamber and is received in the third guide groove, a plurality of dents are defined in the third guide groove, and the spring-loaded ball is movable along the third guide groove and is configured to be positioned in any of the plurality of dents.

7. The wireless charging device of claim 4, wherein an accommodation chamber is provided at a back of the first support member, the shaft is received in the accommodation chamber, the first support member further comprises an elastic member protruding from an inner lateral surface of the accommodation chamber, the barrel defines a plurality of grooves in the outer lateral surface, when the elastic member is fit into one of the plurality of grooves, the barrel is locked to the first support member.

8. The wireless charging device of claim 4, further comprising a rubber ring, wherein the shaft defines an annular groove in the outer lateral surface, the rubber ring is arranged around the shaft and accommodated in the annular groove, the rubber ring is in contact with the inner lateral surface of the receiving chamber of the barrel to provide damping when the barrel rotates relative to the shaft.

9. The wireless charging device of claim 1, wherein the first support member is rotatably connected to the base, and the base comprises a third wireless charging module.
